(19) United States
(12) Patent Application Publication
(10) Pub. No.: US 2008/0311306 A1
(43) Pub. Date: Dec. 18, 2008

(54) SUPERFINE CERAMIC THERMAL SPRAY FEEDSTOCK COMPRISING CERAMIC OXIDE GRAIN GROWTH INHIBITOR AND METHODS OF MAKING

(75) Inventors: T. Danny Xiao, Willington, CT (US); Xinqing Ma, Willington, CT (US)

Correspondence Address: CANTOR COLBURN, LLP, 20 Church Street, 22nd Floor, Hartford, CT, 06103, US

(73) Assignee: INFRAMAT CORPORATION, Farmington, CT (US)

(21) Appl. No.: 12/142,217

(22) Filed: Jun. 19, 2008

Related U.S. Application Data
(63) Continuation-in-part of application No. 11/801,206, filed on May 8, 2007.
Application No. 11/801,206 is a division of application No. 10/405,450, filed on Apr. 2, 2003, now Pat. No. 7,238,219.
Application No. 10/405,450 is a division of application No. 09/846,404, filed on May 1, 2001, now Pat. No. 6,576,036.
Application No. 09/846,404 is a division of application No. 09/138,137, filed on Aug. 21, 1998, now Pat. No. 6,277,774.
(60) Provisional application No. 60/945,001, filed on Jun. 19, 2007.
(60) Provisional application No. 60/057,339, filed on Aug. 22, 1997.

(51) Int. Cl. C23C 4/10; C04B 35/14; C04B 35/04; C04B 35/48; C04B 35/49; C04B 35/057; B05D 3/02

(52) U.S. Cl. 427/453; 501/133; 501/108; 501/103; 501/123; 427/397.7

(57) ABSTRACT

Superfine ceramic thermal spray feedstock compositions and methods of making and using such compositions are provided. In an embodiment, a thermal spray feedstock composition comprises: a superfine ceramic material comprising grains having an average longest dimension of about 100 nanometers to about 500 nanometers; and a grain growth inhibitor comprising a ceramic oxide different from the superfine ceramic material.

### CROSS-REFERENCE TO RELATED APPLICATION

This application claims the benefit of U.S. Provisional Patent Application No. 60/945,001, filed Jun. 19, 2007, which is a continuation-in-part of U.S. patent application Ser. No. 11/801,206, filed May 8, 2007, which is a divisional of U.S. Pat. No. 7,238,219 B2, filed Apr. 2, 2003, which is a divisional of U.S. Pat. No. 6,576,036 B2, filed May 1, 2001, which is a divisional of U.S. Pat. No. 6,277,774 B1, filed Aug. 21, 1998, which claims the benefit of U.S. Provisional Patent Application No. 60/057,339, filed Aug. 22, 1997, wherein priority is claimed from all of the foregoing patent applications, which are incorporated by reference herein in their entireties.

### BACKGROUND OF THE INVENTION

1. Field of the Invention

This invention generally relates to superfine materials, and more particularly to thermal spray feedstock compositions comprising a superfine ceramic material as a primary phase and a ceramic oxide as a grain growth inhibitor and methods of synthesizing such compositions.

2. Brief Description of the Prior Art

Ceramic oxide materials have been widely used as coating materials to improve the surface properties of bulk materials. Such materials are especially useful for applications where wear and corrosion resistances are required simultaneously. For example, alumina/titania ceramic coatings have excellent wear, erosion, fretting, and cavitation resistance, heat resistance up to 540° C., resistance to most acids and bases, resistance to wetting by common aqueous solutions, and high dielectric strengths. The ceramic oxide coatings can be formed by thermally spraying ceramic oxide powders such as alumina/titania, chromia/titania, and zirconia/yttria powders. Metallic and cermet (i.e., a ceramic/metallic material) coatings lack many of the excellent properties possessed by ceramic oxide coatings. Consequently, ceramic oxide coatings prepared through thermal spray processes are used by the U.S. Navy, for example, to repair steam valve stems of naval ships. In addition to naval applications, thermally sprayed ceramic oxide coatings also find applications in land-based gas turbines, diesel engines, cutting tools, medical implants, and catalytic converters. For example, alumina is currently used as a coating in the cutting tool industry for improving chemical or solution related wear. Alumina-coated carbide tools can exhibit speeds up to 2.5 times the speed capability of uncoated carbide tools. Due to its extremely low adhesive wear rate, alumina is also used as a bearing surface in a variety of precision instruments.

Micron sized ceramic oxide materials having grain sizes of about 1 to about 10 micrometers (microns) are currently being used as melt promoters or enhancers in thermal spray feedstock materials. Unfortunately, coatings formed from such feedstock materials can exhibit poor properties such as brittleness, low density, low thermal shock resistance and weak bond strength.

It has been discovered that the replacement of the micron sized ceramic materials with ceramic materials having a smaller grain or particle size in the thermal spray feedstock can achieve a higher quality coating. Of particular interest are the following two classes of such fine-scale microstructures: nanostructured materials comprising grains or particles having an average longest dimension of less than or equal to 100 nanometers (nm); and sub-micron (or superfine) materials comprising grains or particles having an average longest dimension of 100 nm to 1 micron. A feature of such fine materials is the high fraction of atoms that reside at grain or particle boundaries. As a result, fine materials can have substantially different and often superior chemical and physical properties compared to large-sized counterparts having the same composition. Thus, considerable advantages can accrue from the substitution of fine materials for large-structured materials in a wide range of applications, for example, superior strength, improved fracture toughness and hardness in martensitic steels, and reduced sintering temperature for consolidation and the onset of superplasticity in ceramics.

Inframat Corporation has made significant progress in the field of nanostructured and superfine materials, including in the synthesis of nanostructured powders by the organic solution reaction (OSR) method and the aqueous solution reaction (ASR) method, and in advanced chemical processing of oxide and hydroxide materials for battery and fuel cell applications. Examples of materials produced from these methods include nanostructured alloys of Ni/Cr, nanostructured NiCr/Cr₃C₂ composites, nanostructured yttria-stabilized ZrO₂, nanofibrous MnO₂, and Ni(OH)₂. Inframat has further developed technologies for manufacturing nanostructured and ultrafine materials in bulk quantities as disclosed in U.S. and foreign applications entitled “Nanostructured Oxide and Hydroxide Materials and Methods of Synthesis Therefor” (including U.S. Pat. No. 6,162,530, filed Nov. 17, 1997). It has also developed technologies for the thermal spraying of nanostructured and ultrafine feeds, including nanostructured WC—Co composites as disclosed in U.S. and foreign patent applications entitled “Nanostructured Feeds for Thermal Spray Systems, Method of Manufacture, and Coating Formed Therefrom” (including U.S. Pat. No. 6,025,034, filed Feb. 5, 1998). Chemical syntheses of nanostructured metals, ceramics, and composites using OSR and ASR methods have also been previously described by Xiao and Strutt in “Synthesis and Processing of Nanostructured Ni/Cr and Ni—Cr₃C₂ Via an Organic Solution Method,” Nanostructured Mater. Vol. 7 (1996) pp. 857-871 and in “Synthesis of Si(C,N) Nanostructured Powders From an Organometallic Aerosol Using a Hot-Wax Reactor,” J. Mater. Sci. Vol. 28 (1993), pp. 1334-1340.

The OSR and ASR methods employ a step-wise process generally comprising (1) preparation of an organic (OSR) or aqueous (ASR) solution of mixed metal halides; (2) reaction of the reactants via spray atomization to produce a nanostructured precipitate; and (3) washing and filtering of the precipitate. The precipitate is then often heat treated and/or subjected to gas phase carburization under either controlled carbon/oxygen activity conditions (to form the desired dispersion of carbide phases in a metallic matrix phase) or under controlled nitrogen/hydrogen activity conditions to form nanostructured nitrides. This procedure has been used to synthesize various nanostructured compositions, including nanostructured NiCr/Cr₃C₂ powders for use in thermal spraying of corrosion resistant hard coatings. An advanced chemical processing method combines the ASR and OSR methods with spray atomization and ultrasonic agitation.

Another approach to the synthesis of nanostructured materials is the inert gas condensation (IGC) method. As described in “Materials with Ultrafine Microstructures: Retrospective and Perspectives”, Nanostructured Materials Vol. 1, pp. 1-19, Gleiter originally used this method to produce nanostructured metal and ceramics clusters. The method was later extensively used by Siegel to produce nanostructured TiO₂ and other systems, as described in “Creating Nanophase Materials”, Scientific American Vol. 275 (1996), pp. 74-79. This method is the most versatile process in use today for synthesizing experimental quantities of nanostructured metals and ceramic powders. The IGC method uses evaporative sources of metals, which are then convectively transported and collected on a cold substrate. Ceramic particles must be obtained by initially vaporizing the metal source, followed by a slow oxidation process. A feature of this method is the ability to generate loosely agglomerated nanostructured powders, which are sinterable at low temperatures.

One other method for the synthesis of nanostructured materials is chemical vapor condensation (CVC). CVC is described by Kear et al. in “Chemical Vapor Synthesis of Nanostructured Ceramics” in Molecularly Designed Ultra fine/Nanostructured Materials in MRS Symp. Proc. Vol. 351 (1994), pp. 363-368. In CVC, the reaction vessel is similar to that used the IGC method but instead of using an evaporative source, a hot-wall tubular reactor is used to decompose a precursor/carrier gas to form a continuous stream of clusters of nanoparticles exiting the reactor tube. These clusters are then rapidly expanded out to the main reaction chamber, and collected on a liquid nitrogen cooled substrate. The CVC method has been used primarily with chemical precursors or commercially available precursors. Kear describes the production of nanostructured SiCₓN_{y} and oxides from hexamethyldisilazane.

Finally, a thermochemical conversion method for producing nanostructured WC—Co has been disclosed by Kear in “Synthesis and Processing of Nanophase WC—Co Composite” Mater. Sci. Techn. Vol. 6 (1990), p. 953. In this method, aqueous solutions containing tungsten and cobalt precursors are spray-dried to form an intermediate precursor at temperatures of about 150 to 300° C. This intermediate precursor is a mixture of amorphous tungsten oxide and cobalt in the form of a spherical hollow shell having a diameter of about 50 microns and a wall thickness of about 10 microns. Nanostructured WC—Co is then obtained by the carburization of this precursor powder at 800-900° C. in a carbon monoxide/carbon dioxide mixture. The synthesis of nanostructured WC/Co using this technique has been described in several patents by McCandlish et al., including U.S. Pat. Nos. 4,851,041, and 5,230,729. Synthesis of nanostructured and superfine WC/Co is of particular interest to industry, as is it is presently the material of choice for cutting tool, drill bit, and wear applications.

It is expected that a number of the techniques developed especially for nanostructured materials are also applicable to synthesis of superfine materials, through controlled manipulation of grain size either at the synthetic level or through the use of grain growth inhibitors. However, a major drawback of the above-described techniques and other current techniques for synthesizing superfine materials is the tendency of the produced materials to experience extremely fast grain growth during processing at extremely high temperatures, for example, during sintering, due to its high surface energy nature. For example, the grains of superfine ceramic particles such as tungsten carbide (WC) or alumina (Al₂O₃) can grow from a few nanometers up to tens of microns in a fraction of a second. Unfortunately, thermal spray techniques employ very high temperatures. For example, the high velocity oxygen flame (HVOF) technique can be performed at several thousands of degrees Celsius, and the plasma technique can be performed at temperatures as high as fifteen thousand degrees Celsius. Grain growth can be rapid at such temperatures. Therefore, grain growth in thermal sprayed coatings can be a serious obstacle in the production of superfine coatings.

Accordingly, there remains a need for methods of inhibiting and/or reducing grain growth during the processing of superfine materials.

### SUMMARY OF THE INVENTION

The above discussed and other drawbacks and deficiencies of the prior art are overcome or alleviated by the thermal spray feedstock compositions described herein. In an embodiment, a thermal spray feedstock composition comprises: a superfine ceramic material comprising grains having a dimension of about 100 nanometers to about 500 nanometers; and a grain growth inhibitor comprising a ceramic oxide different from the superfine ceramic material.

In another embodiment, a method of making a superfine composition for use in thermal spraying comprises: mixing a superfine ceramic material comprising grains having a dimension of about 100 nanometers to about 500 nanometers with a ceramic oxide grain growth inhibitor that is different from the superfine ceramic material to form a solid mixture; combining the solid mixture with a liquid to form a slurry; and spray drying the slurry to form a reconstituted composite material.

In yet another embodiment, a method of coating a surface comprises: thermal spraying a superfine composite material to form a coating on the surface, the composite material comprising: a superfine ceramic material comprising grains having a dimension of about 100 nanometers to about 500 nanometers; and a grain growth inhibitor comprising a ceramic oxide different from the superfine ceramic material.

### BRIEF DESCRIPTION OF THE DRAWINGS

The above described and other features are exemplified by the following detailed description taken in conjunction with the accompanying drawings in which:

FIG. 1 illustrates a thermal spray process utilizing a ceramic feedstock having micrometer sized grains;

FIGS. 2a-2b illustrate two embodiments of a superfine ceramic composite for use as a thermal spray feedstock and particularly show the relationship between the main ceramic phase and the ceramic oxide grain growth inhibitor phase;

FIG. 3 illustrates a thermal spray process utilizing a superfine ceramic feedstock comprising a ceramic oxide grain growth inhibitor;

FIG. 4 depicts a graph illustrating the effect of increasing amounts (weight %) of boron nitride on hardness of a tungsten carbide/cobalt nanostructured composite material;

FIGS. 5a-5f depict the Vicker's hardness data of the samples from the thermal spray trials;

FIG. 6 depicts a graph illustrating the effect of the toughness as function of alloy addition with 1 wt. % boron nitride grain growth inhibitor;

FIG. 7 depicts SEM micrographs of a thermal spray feedstock which includes a superfine composite having alumina as a primary phase and titania and ceria as grain growth inhibitors, wherein the micrographs show (a) the general morphology of the composite and (b) the composite at higher magnification; and

FIG. 8 depicts a graph illustrating wear volume comparisons of (a) a micron sized Al₂O₃ coating with TiO₂ added as a grain growth inhibitor, (b) a nanostructured Al₂O₃ coating with TiO₂ added as a grain growth inhibitor, (c) a superfine Al₂O₃ coating with TiO₂, CeO₂, Y₂O₃, and ZrO₂ added as grain growth inhibitors, and (d) a nanostructured Al₂O₃ with TiO₂, CeO₂, CeO₂, Y₂O₃, and ZrO₂ added as grain growth inhibitors.

### DETAILED DESCRIPTION OF THE INVENTION

Disclosed herein are methods for the incorporation of grain growth inhibitors and/or alloying additives into superfine materials. As used herein, the term “superfine materials” refers to materials comprising grains or particles having an average longest dimension (or size) greater than about 100 nm and less than or equal to about 10 microns. In one embodiment, a method for the inhibition of grain growth during processing of powder materials comprises incorporation of a grain growth inhibitor polymer precursor into superfine materials or intermediates useful for the production of superfine materials for bulk and coating applications. The polymer precursor and/or alloying additive is incorporated into the superfine material or intermediate either as the material is synthesized or after synthesis (preferably at the as-synthesized intermediate stage). Incorporation of the polymer precursor and optional alloying additive as the material is synthesized is preferable, as the number of processing steps is reduced, the method is more cost-effective, and it is more likely that the grain growth inhibitor is uniformly distributed. Therefore, superfine materials can be fabricated with controlled morphology, microstructure, and chemical composition. The superfine materials obtained in this manner can be used as feedstocks for superfine coatings as well as in advanced, high performance bulk applications.

Without being bound by theory, it is hypothesized that the surprisingly good results obtained by the foregoing method arise from effective distribution of the grain growth inhibitor substantially onto the grain boundaries, as such distribution minimizes grain growth due to the difficult diffusion path for atoms across the grain boundaries. With reference to the boron nitride (BN) grain growth inhibitor in the tungsten cobalt/cobalt (WC/Co) system in particular, cluster stabilization in the cobalt-rich melt by the presence of a high concentration of metal/non-metal binding pairs may be an important factor, since it inhibits liquid phase transport of tungsten and carbon from one WC grain to the next adjacent grain. Upon addition of BN to the Co, melt BN may pass into solution in the liquid Co; under these circumstances the melt, which is already rich in tungsten and carbon in the case of nanophase material, would become further enriched in boron and nitrogen, so that the potential for cluster stabilization is enhanced. With the addition of alloying additives such as Cr, Si, and the like, the complexity of the melt increases, giving rise to the so-called confusion principle, which determines the susceptibility of a liquid melt to amorphization. Boron is a melt depressant of transition elements, and Allied Signal METGLASS technology uses the addition of boron to iron, nickel, and cobalt. In the present instance, boron may also be playing a role as a melt depressant, rendering the compacted material more susceptible to densification at low temperatures, as well as promoting amorphization during subsequent cooling. An alternative possibility is that nitrogen reacts with the WC interfaces to form a passivation film of W₂N or a tungsten carbon nitride. In either case, the effect would be to inhibit coarsening due to the presence of the passivation film.

Superfine materials suitable for use in the present invention include but are not limited to metal, metal alloys, metal ceramics (especially metal carbides and metal nitrides), intermetallics, ceramics, or ceramic-ceramic composites. Preferred superfine materials are selected from the group consisting of Cu, FeCu, FeCo, NiAl, MoC, MoSi, NiCr, TiC, Mo₂Si, NiCr/Cr₃C₂, Fe/TiC, Ni/TiC, Mo/TiC, and WC/Co, the foregoing alloyed with one or more of Ti, Cr, Mo, Ni, Zr, Ce, Fe, Al, Si, V, TiC, Mn, Y, W, and a combination comprising at least one of the foregoing materials. Sulfide-metal systems are excluded from the foregoing list.

The grain growth inhibitors for incorporation into the superfine materials are desirably chemically inert, amenable to uniform distribution onto or at the grain boundaries of the superfine material. Further, the grain growth inhibitors desirably add to, or at least do not detract substantially from, the chemical, physical, and mechanical properties desired in the superfine materials. The inhibitors are also desirably available in a precursor form suitable for incorporation into superfine materials. The grain growth inhibitors can be incorporated into the superfine materials in the form of a soluble, preferably water-soluble, polymeric precursor, or in the form of a low-melting polymer precursor. Use of a soluble precursor allows more homogenous distribution of the precursor (and thus grain growth inhibitor) throughout the superfine material. Use of a low-melting polymer precursor, i.e., a precursor that melts a temperature below the grain growth temperature of the superfine material, also allows more homogenous distribution of the precursor throughout the superfine material. Of course, the precursor must be capable of subsequent conversion to the grain growth inhibitor upon treatment, preferably upon heat treatment.

Suitable grain growth inhibitors having the above characteristics include but are not limited to those known in the art, including metals, metal alloys, carbides, nitrides, intermetallics, and ceramics. Particular grain growth inhibitors include metals such as B, Si, Al, Cr, Ni, Mo, Hf, Ta, Fe, W, and Zr; rare earth metals such as Ce, La, and Sm; metal alloys such as the foregoing alloyed with, for example, Cr, Ti, and Mo; carbides such as silicon-based carbides and titanium-based carbides; nitrides such as aluminum-based nitrides, titanium-based nitrides, and BN; intermetallics, including metal suicides such as AlSi and TiSi and metal aluminides such as TiAl; and other boron compounds such as titanium diboride. Boron compounds, and particularly boron nitride, is presently preferred, due to its ready synthetic availability, its favorable distribution characteristics, its chemical inertness, and its superior chemical, physical, and mechanical properties.

Synthesis of a polymer precursor that will yield a grain growth inhibitor generally comprises forming an inorganic polymer from a solution of metal salts, filtering the polymer, and drying the polymer to obtain a dried polymer precursor. In the case of boron nitride, the appropriate stoichiometric ratio of boric acid and urea is dissolved in a solvent, preferably in water. A nitriding gas such as ammonia is then bubbled through the solution, making it strongly basic, until the metal precursor salts have been converted into an inorganic polymer precursor which will yield boron nitride upon heat treatment. The product is dried to yield a precursor polymer gel, which can be stored in the dry form.

A first embodiment of the present invention comprises the in-situ incorporation of the polymer precursor into the superfine products or superfine intermediates (usually a powder) as the superfine materials or intermediates are synthesized. Suitable synthesis techniques include but are not limited to those known in the art such as OSR, ASR, IGC, CVC, mechanical alloying, or other physical and chemical techniques. OSR and ASR techniques are presently preferred. In this embodiment, the polymer precursor is dissolved into a solvent, preferably water, containing the superfine material precursor(s) at controlled temperature in ratios selected as appropriate for the desired product. While dissolving the salts, the pH of the solution is controlled to prevent premature reaction of the salts.

The resulting solution is then spray-dried or oven dried, depending on the material's application, to form a solid, dried superfine powder product or intermediate. The spray drying process is generally a preferred process. Control of the spray-drying parameters allows formation of different powder morphologies, including spherical hollow shells and solid spheres of varying porosity and structure. During the drying process, the solution droplets reach elevated temperatures and become more concentrated as the solvent evaporates. Some or complete conversion of polymeric precursor to grain growth inhibitor may occur during spray-drying or oven-drying.

If required these dried powders are then treated, preferably heat treated, optionally under conditions of reduction and carburization or nitridation where required to produce the desired superfine product. The grain growth inhibitor precursor is partially or completely converted at this step to the grain growth inhibitor. Selection of appropriate carburization or nitridation conditions is well within the skill of those in the art and requires the selection of an appropriate temperature and gas ratio with controlled C, O, or N activity in order to develop the desired particle size distribution. For example, the oxide can be reduced with ammonia/hydrogen gas at an elevated temperature (e.g., about 600 to 800° C.).

In a second embodiment, the polymer precursor is incorporated into already-synthesized superfine materials or superfine intermediate materials. This embodiment comprises coating superfine particles (such as the subparticles of superfine WC/Co) with the polymeric precursor and heat treating the coated materials if necessary at a temperature lower than the grain growth temperature of the material, thereby resulting in diffusion of the polymeric precursor through any matrix of the material and onto the grain boundaries. The combined polymer precursor-nanostructured material or intermediate composite is then treated, preferably heat treated, under controlled gas conditions at elevated temperature in order to decompose the polymer precursor and to further diffuse the grain growth inhibitor to the grain boundaries.

In particular, the polymer precursor is either melted or dissolved directly onto the superfine material or intermediate, which is preferably in powder form. The polymer precursor is preferably dissolved in a solvent and added to either the superfine material or a slurry of the material. Where the particles are small enough or porous enough to allow sufficiently fine distribution of the polymer precursor throughout the material, a solution of appropriate concentration of precursor is used to wet the powder, and the resultant powder is simply air- or oven-dried onto the powder. Alternatively, the coated superfine particles are heat-treated for a time effective to disperse the polymer precursor into the superfine material or intermediate, at a temperature lower than the grain growth temperature of the superfine material.

Where the superfine particles are smaller than the desired final powder size, spray drying of a slurry of the polymer precursor and superfine material enhances diffusion and results hollow or solid spherical agglomerates having diameters in the range of 1-200 microns. Spray drying of the slurry results in the formation of a dried powder wherein the grain growth inhibitor is substantially uniformly distributed onto the grain boundaries of the superfine particles. The dried powder is in the form of solid spheres having diameters in the range of about 1 to 200 microns, each sphere comprising an assemblage of individual superfine particles.

Where necessary the coated material, whether spray-dried, oven-dried, or air-dried, is then treated, preferably heat treated in a controlled gas environment at elevated temperatures, to decompose the inhibitor precursor, and to further diffuse the inhibitor atoms through any matrix material (if present) onto the grain boundaries of the superfine particles. Carburization or nitridation may also occur at this step. Subsequent processing of the composite superfine powders in a controlled environment results in the formation of either bulk materials or coatings with superior properties.

In another embodiment, at least one alloying additive is incorporated into the superfine material with or without incorporation of a grain growth inhibitor. The alloying additive can be any metallic or ceramic powder effective to alloy with the superfine material by the below-described or other process, and which does not significantly adversely affect the action of the grain growth inhibitor if present. Suitable alloying additives include, but are not limited to, Ti, Cr, Mo, Ni, Zr, Ce, Fe, Al, Si, V, TiC, Mn, Y, W, alloys of the foregoing, nitrides of the foregoing, and intermetallics of the foregoing.

One or more alloying additives can be introduced at virtually any point in the methods described herein. Thus, alloying additives can be introduced into the reaction mixture used to synthesize the superfine material or superfine intermediate material, and if present, the grain growth inhibitor precursor can be incorporated into the reaction mixture either before (first embodiment above) or after (second embodiment above) synthesis of the superfine material or superfine intermediate material. The alloying additives can also be incorporated into the already-synthesized superfine material or superfine intermediate material, which synthesis also incorporates grain growth inhibitor precursor if present as described in the first embodiment above. Preferably, the alloying additive and grain growth inhibitor precursor are incorporated into an as-synthesized superfine material or superfine intermediate material simultaneously.

One suitable method for incorporating an alloying additive(s) is by ball milling the alloying additive(s) to obtain a more uniform powder mixture and then dispersing the alloying additive(s) into a solution comprising the inorganic polymeric grain growth inhibitor, thereby forming a colloidal solution. The superfine material or superfine intermediate material is then mixed with the colloidal solution, and the resultant solution is spray-dried or oven-dried. The alloying additive(s) can also be introduced into the already-synthesized material or intermediate material by ball milling the alloying additive together with the superfine materials, followed by incorporation of the polymeric grain growth inhibitor as described above in connection with the second embodiment.

An apparatus suitable for the synthesis and introduction of a precursor into a superfine material includes a solution reaction vessel, ball milling apparatus or an ultrasonic processing system, a spray dryer, equipped with the usual and necessary accessories such as pH meter, temperature and gas flow controls, vacuum systems, as well as a high temperature carburization unit (fixed bed, moving bed, or fluidized bed reactor).

The carburization or nitridation equipment can be fixed bed reactors, fluidized bed reactors, and/or moving bed reactors. In the carburization, reactive gas such as H₂, CO/CO₂, NH₃, acetylene, N₂, Ar can be used. In a fluidized bed reactor, the solid particles are suspended by the fluidizing gas increasing the total volume and spacing the particles so that they are in constant motion, and are not continuously contacting one another. The particles are thus constantly exposed to the reactive gas, leading to much faster and efficient carburization process, and reduced agglomeration of the spray dried particles. An advantage to using such a reactor is its ability to manufacture large batch quantities of powder for commercial use. From a production point of view, however, the moving bed reactor is the preferred reactor, because the moving bed reactor is suitable for a continuous production line, and may be more efficient in both energy consumption and gas consumption.

### Superfine Composite Materials Comprising Ceramic Oxide Grain Growth Inhibitors

In another exemplary embodiment, a superfine ceramic thermal spray feedstock composition includes a primary ceramic phase and a ceramic oxide as a grain growth inhibitor uniformly distributed among the primary ceramic phase. Alternatively, the ceramic oxide grain growth inhibitor can be in the form of a matrix phase in which particles of the primary ceramic phase are embedded. Both the primary ceramic phase and the grain growth inhibitor can comprise superfine ceramics, particularly superfine ceramics comprising grains or particles having an average longest dimension (i.e., grain size) of about 100 nm to about 500 nm. The grain growth inhibitor serves to inhibit or reduce the grain growth of the primary ceramic phase. It also can act as a melt enhancer. Examples of suitable grain growth inhibitors include but are not limited to transition metal oxides (e.g., titania or zirconia), alkaline earth metal oxides (e.g., CaO or MgO), rare earth element oxides (e.g., yttria or ceria), metalloid oxides (e.g., silica), weak metal oxides (e.g., alumina), and combinations comprising at least one of the foregoing ceramic oxides. The amount of grain growth inhibitor present in the superfine composite composition is about 0.1 wt. % to about 50 wt. % based on the weight of the primary ceramic phase.

Specific examples of the superfine composite compositions include: a composite comprising alumina as a primary phase and at least one of the following grain growth inhibitors: titania, yttria, ceria, zirconia, silica, and magnesium oxide; a composite comprising titania as the primary phase and at least one of the following grain growth inhibitors: alumina, yttria, ceria, zirconia, silica, and magnesium oxide; a composite comprising chromia as a primary phase and at least one of the following grain growth inhibitors: titania, alumina, yttria, ceria, zirconia, silica, and magnesium oxide; and a composite comprising zirconia as the primary phase and at least one of the following grain growth inhibitors: titania, alumina, yttria, ceria, silica, and magnesium oxide.

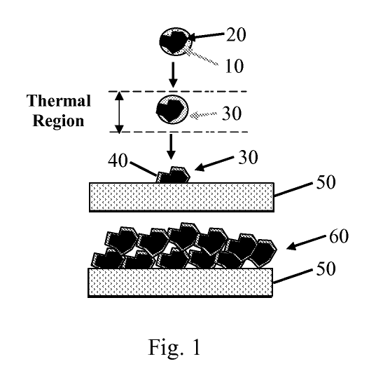

Turning now to the drawings, for comparison purposes, FIG. 1 illustrates a thermal spray process in which micron sized powders are used as the feedstock as opposed to superfine powders. In particular, FIG. 1 shows micron sized titania powders 10 being clogged on the surfaces of micron sized alumina powders 20 (shown as a solid phase) or mixed with the alumina powders to form a composite 30. This composite 30 is then subjected to thermal spraying, which causes the composite 30 to experience melting at its surface 40 rather than bulk melting as it is deposited onto the surface of a substrate 50. This surface melting occurs as a result of the relatively low melting point of the titania particles. A plurality of such composites 30 can be thermally sprayed upon the substrate 50 to form a coating 60. Because of the relatively large grain sizes of the micron sized ceramic materials present in the composites 30, the coating 60 formed on the substrate 50 has inferior properties. For example, the coating 60 can be highly porous and non-uniform and can include cracks. Additional disadvantages of the coating 60 are that it is very brittle, has a relatively low density, and exhibits a relatively low thermal shock resistance and a relatively weak bond strength with the substrate.

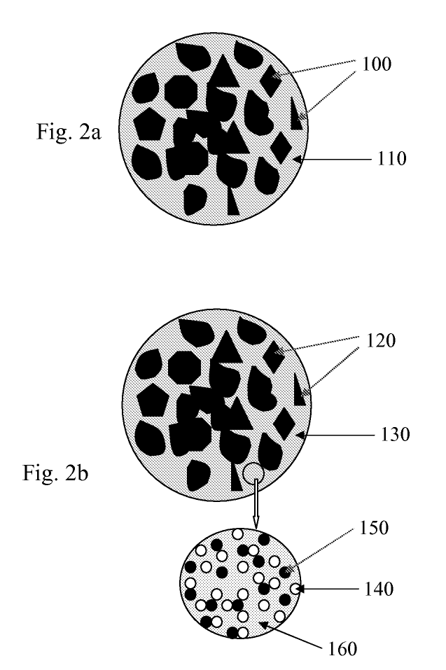

FIGS. 2a and 2b illustrate two exemplary embodiments of the superfine ceramic composite compositions described herein. In the first embodiment shown in FIG. 2a, particles 100 of the primary ceramic phase are uniformly distributed throughout the grain growth inhibitor 110, which is in the form of a matrix phase. In the second embodiment shown in FIG. 2b, particles 120 of the primary ceramic phase are also uniformly distributed throughout the grain growth inhibitor 130; however, in this case the grain growth inhibitor 130 includes metal oxide particles 140 and rare earth oxide particles 150 distributed in a ceramic oxide matrix phase 160. In an alternative embodiment (shown later), the particles of the grain growth inhibitor can be uniformly mixed with particles of the primary ceramic material.

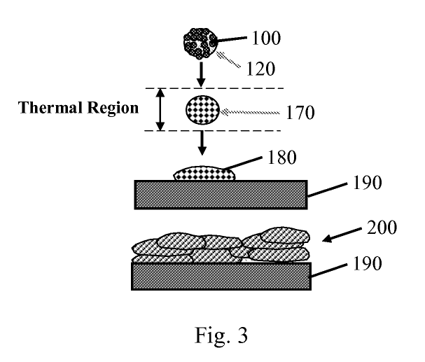

FIG. 3 illustrates a thermal spray process using the superfine composite compositions described herein. In the embodiment shown in FIG. 3, superfine ceramic oxide particles 120 are uniformly mixed with superfine primary ceramic particles 100 to forming a composite material 170. The ceramic oxide particles 120 desirably have a relatively low melting point and thus act as a soft phase for splat formation and as a grain growth inhibitor to prevent growth of the grains in the primary ceramic phase 100. The composite material 170 can be subjected to thermal spraying, causing it to experience relatively uniform melting and form a molten phase. As a result, a more homogeneous and dense coating 180 is formed on substrate 190. Due to the use of a superfine feedstock, the coating 180 is less porous than a coating formed using a micron sized ceramic feedstock. A plurality of composite materials 170 can be thermally sprayed upon the substrate 190 to form a relatively uniform coating 200 across the entire surface of substrate 190.

The coatings formed by thermal spraying of such superfine composite compositions exhibit improved density, toughness, wear-resistance, thermal shock resistance, and bond strength. These improved coatings can be applied to devices or components such as land-based gas turbines, diesel engines, cutting tools, medical implantation devices, steam valve stems, piston rings, cylinder liners, rollers, etc. The coatings significantly increase the service life of those devices or components.

According to an exemplary embodiment, the superfine ceramic composite compositions described herein can be made by a method that comprises powder mixing, de-agglomeration, powder dispersion, addition of binders, spray drying or reconstitution, heat treatment, and size selection. This method can be performed using a mixer (mechanical, magnetic, or ultrasonic), a ball milling apparatus, a spray drier, and an oven or a high temperature furnace. Details of the processing steps are described as follows.

The powder mixing process involves mechanically mixing the superfine starting materials, i.e., the primary ceramic material and the ceramic oxide grain growth inhibitor, using a blending technique. As such, the starting materials are pre-mixed prior to subsequent processing steps. Also, if the powder includes loosely agglomerated particles, this step can help cut down powder dust in the de-agglomeration step and control the morphology of other processing steps. The foregoing can be accomplished by mixing the powder in a solvent and subsequently evaporating the solvent to form a cake-like structure, thus eliminating the dust nature of the composite.

The de-agglomeration process serves to de-agglomerate any ceramic particle aggregates and to achieve high homogeneity in the powder mixture. This process can be accomplished via a mechanical milling process, which can optionally be followed by a high-energy ball milling process. Parameters in this process that can be adjusted to achieve the desired results include ball milling energy, ball milling time, and loading ratio of balls/powder/lubricant.

The powder dispersion process can be performed by dispersing the milled powder mixture in an aqueous solution such as deionized water or an organic solution to form a slurry. Suitable surfactants optionally can be added to the slurry to assess its potential for achieving optimal homogeneity of the dispersed composite. Parameters in this process that can be adjusted to achieve the desired results include the solid/liquid loading ratio and the rheological behavior of the slurry. Suitable binder compounds can be added to the slurry prior to spray drying. Examples of suitable binder compounds include but are not limited to polyvinyl alcohol (PVA), polyvinyl pyrrolidone (PVP), combinations comprising at least one of the foregoing, etc. A range of binder compound concentrations can be used in the slurry.

The reconstitution process can be conducted using a spray drying technique. That is, the slurry can be spray-dried in hot air to form larger spherical shaped agglomerates. While many suitable non-reactive gases or mixtures thereof can be used, nitrogen or argon is preferred. The temperature at which the slurry is spray-dried can be, for example, about 150° C. to about 350° C., more specifically about 150° C. to about 250° C. The agglomerates can further be optionally subjected to a high temperature, e.g., about 350° C. to about 500° C., to remove the binder. Parameters in this process that can be adjusted to achieve the desired results include slurry concentration, slurry delivery rate, drying temperature, and atomizing speed.

The heat treatment process can be performed on the agglomerated powder to produce a composite material with optimal flow characteristics, physical stability, and optimal morphology for use in thermal spraying. The temperature used for the heat treatment process can be, for example, about 800° C. to about 1200° C. Properties of the this process include: degree of binder burn-out, particle sintering characteristics and thermal changes of the agglomerated powder, particles in the plasma, porosity, morphology, and size and density of the composite material. Optionally, the composite material can be plasma processed after heat treatment to increase its tapping density and flowability.

Particle size selection can be performed by screening the agglomerated powder using a mesh size suitable for thermal spray applications. The screened powder can also be subjected to air classification to eliminate those particles smaller than 5 or 10 microns in size. The larger particles that do not pass through the mesh can additionally be subjected to hammer milling to reduce their size, allowing them to also be used for thermal spray applications.

The invention is further illustrated by the following non-limiting examples.

### EXAMPLES

### Example 1

### Synthesis of a Grain Growth Inhibitor Polymer Precursor

Boric acid (H₃BO₃) and urea ((NH₂)₂CO) purchased from Aldrich Chemical Company of Milwaukee, Wis. were used as received. Initially, 61.831 g (1 mol) of boric acid and 63.784 g (1.062 mole) of urea were dissolved in 1 liter of deoxygenated water. After thorough mixing, the aqueous solution was slowly heated to 90° C. Ammonia was bubbled into the solution with vigorous stirring until the solution was strongly basic. After 4 hours of reaction, the water was removed by distillation, leaving as a residue the polymeric precursor in the form of an amorphous solid weighing approximately 80 grams. It is hypothesized that in the presence of ammonia, boric acid reacts with urea to form a poly-urea-boron complex. This boron nitride precursor is a gel-like white resin that is highly soluble in water, and which is readily ground into powder. Upon heating to a higher temperature in the presence of ammonia, the gel initially melted at about 200° C., forming a foam-like glassy material, and upon continued heating at about 500 to 650° C., it transformed into BN in the form of a white powder.

### Example 2

### Incorporation of BN into Nanostructured Materials

A known quantity of BN polymeric precursor synthesized as described in Example 1 was first dissolved in distilled, deionized water to make a nearly saturated solution. This solution was then combined with hollow shell nanostructured WC—Co (used as received from Nanodyne, Inc., New Brunswick, N.J.) and ball milled to produce a slurry. The milled slurry was then dried in an oven at about 100° C. to remove water. A number of samples were prepared wherein the molar percent of boron in the BN was 0.1%, 0.25%, 0.5%, 1%, 2%, 5%, and 10%. Converted to weight percent (wt. %), these values correspond to 0.006 wt. %, 0.015 wt. %, 0.03 wt. %, 0.06 wt. %, 0.119 wt. %, 0.293 wt. %, and 0.569 wt. % of boron in BN, respectively.

### Example 3

### Sintering of Precursor/Nanostructured Material Intermediates

The milled samples of Example 2 (as well as a sample of WC—Co powder as received) were sintered by first pressing about 10 g of each sample into 1.5 cm discs and then heat treating each sample at 1400° C. under flowing argon gas using a heating rate of 10° C./minute and a dwell time of 0.5 hour. After heat treatment, the resultant pellets had shrunk to approximately half of their original sizes, and had densified to varying degrees, up to about 99% density.

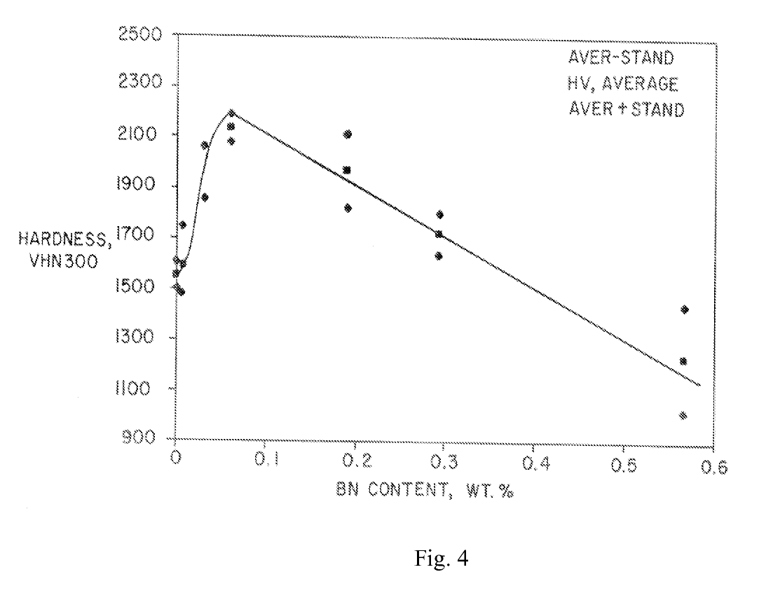

The Vicker's hardness values (VHN, 300 g) of these samples are shown graphically in FIG. 4. The average hardness of the sample having 0.0 wt. % of boron is about 2135, with the highest values up to 2228. All of these samples are reasonably tough. For example, when measuring conventional WC—Co (which has a VHN of 1200 to 1600), cracks at the corners of each diamond indentation always appear. No visible cracks at the indents in the nanostructured WC—Co materials appeared in any of the samples examined.

### Example 4

### Solid Diffusion of Precursor into Grain Boundaries (Argon Treatment)

The milled samples of Example 2 having 1 molar % and 10 molar % boron in BN were heat treated under argon at 600° C. for 5 hours. The treated powders were then pressed into 1.5 cm pellets, and heat treated at 1400° C. under flowing argon gas using a heating rate of 10° C./minute and a dwell time of 0.5 hour. After heat treatment, the resultant pellets had shrunk to approximately half of their original sizes, and had densified to varying degrees up to about 99% density.

### Example 5

### Solid Diffusion of Precursor into Grain Boundaries (Hydrogen Treatment)

The milled samples of Example 2 having 1 molar % and 10 molar % boron in BN were heat treated under hydrogen at 600° C. for 5 hours. The treated powders were then pressed into 1.5 cm pellets, and heat treated at 1400° C. under flowing argon gas using a heating rate of 10° C./minute and a dwell time of 0.5 hour. After heat treatment, the resultant pellets had shrunk to approximately half of their original sizes, and had densified to varying degrees up to about 99% density.

### Example 6

### Solid Diffusion of Precursor into Grain Boundaries (Ammonia Treatment)

The milled samples of Example 2 having 1 molar % and 10 molar % boron in BN were heat treated under ammonia at 600° C. for 5 hours. The treated powders were then pressed into 1.5 cm pellets, and heat treated at 1400° C. under flowing argon gas using a heating rate of 10° C./minute and a dwell time of 0.5 hour. After heat treatment, the resultant pellets had shrunk to approximately half of their original sizes, and had densified to varying degrees up to about 99% density.

### Example 7

### Thermal Spray Trials

The milled sample of Example 2 comprising 0.06 wt. % of boron was prepared in large quantity (about 1 lb) for thermal spray trials. The thermal spray trials were carried out with a METCO 9 MB arc plasma spray gun. The spray conditions are summarized in Table 1 below.

TABLE 1

| | Stand off | | Arc | Primary | Relative | Relative |
|---|---|---|---|---|---|---|
| Trial | Distance | Volt- | Current | Gas Flow | Temp. | Time |
| No. | (inches) | age | (amps) | (scfm) | (A/scfm) | (inch/scfm) |
| 1 | 4 | 65 | 450 | 150 | 3.0 | 0.027 |
| 2 | 4 | 65 | 400 | 150 | 2.7 | 0.027 |
| 3 | 4 | 65 | 400 | 150 | 2.7 | 0.027 |
| 9 | 4 | 65 | 400 | 150 | 2.7 | 0.027 |
| 10 | 4 | 65 | 450 | 200 | 2.3 | 0.020 |
| 11 | 2.5 | 65 | 450 | 200 | 2.3 | 0.013 |
| 12 | 4 | 65 | 450 | 250 | 1.8 | 0.016 |
| 13 | 4 | 65 | 450 | 150 | 3.0 | 0.027 |
| 14 | 4 | 65 | 450 | 200 | 2.3 | 0.020 |
| 15 | 4 | 65 | 400 | 200 | 2.0 | 0.020 |
| 16 | 4 | 65 | 600 | 250 | 2.4 | 0.016 |

Physical properties of the thermally sprayed materials are summarized in Table 2 below.

TABLE 2

| Trial | Relative Wear | | | | | | HV300 |
|---|---|---|---|---|---|---|---|
| No. | Resistance | Desirability* | HV300 | HV300 | HV300 | HV300 | (Average) |
| 1 | 3 | 0.53 | 786 | 1051 | 855 | | 898 |
| 2 | 2 | | | | | | |
| 3 | 9 | 1.00 | 1042 | 829 | 1377 | | 1083 |
| 9 | 8 | 0.79 | 446 | 1215 | 622 | | 761 |
| 10 | 1 | 0.24 | 618 | 836 | 406 | 369 | 557 |
| 11 | 5 | 0.43 | 348 | 427 | 295 | | 357 |
| 12 | 0.05 | 0.04 | 385 | 275 | 267 | | 309 |
| 13 | 6 | 0.61 | 550 | 459 | 715 | 675 | 600 |
| 14 | 5 | 0.48 | 389 | 484 | 496 | | 456 |
| 15 | 8 | 0.65 | 639 | 402 | 499 | | 513 |
| 16 | 1.5 | | | | | | |

*Desirability = [(Structure retained/Maximum structure retained) × (Average thickness/Maximum Average Thickness)]^{0.05}

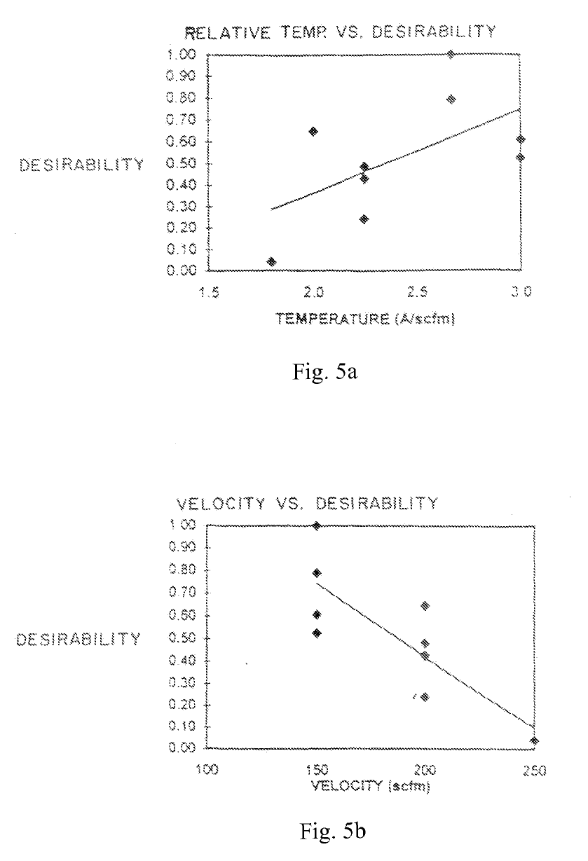

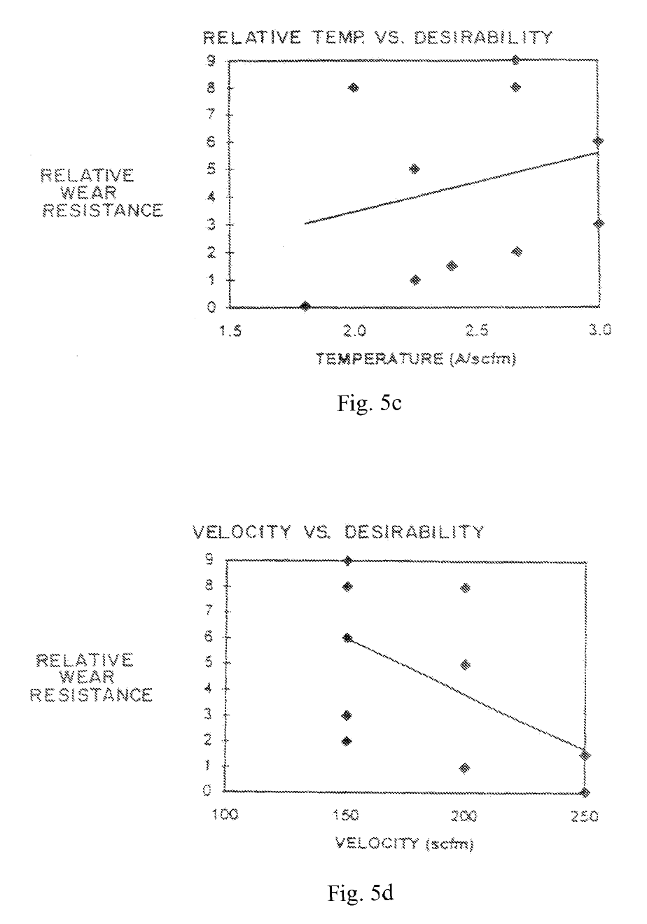

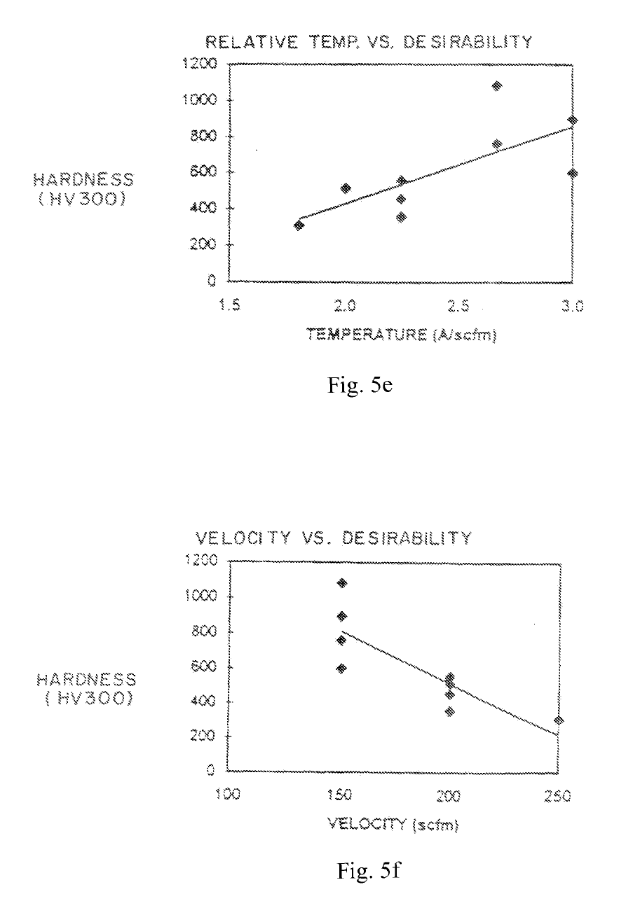

SEM examination indicated that trial No. 3 yielded the material with the best bonding and microstructure. The Vicker's hardness values of these samples in cross-section and perpendicular to the coating were measured, and the results are summarized in FIGS. 5a-5f. The data in FIG. 5a-5f shows the relationship of coating properties for different plasma conditions in the thermal spray trials. The coating properties include relative wear resistance, hardness and desirability.

### Example 8

### In-Situ Synthesis of Nanostructured Powders with Grain Growth Inhibitor

An aqueous solution was prepared by dissolving 22.64 g (7.70 mmol) of (NH₄)₆W₃₉O₁₂□H₂O (ammonium metatungstenate), 9.88 g (34 m mol) of Co(NO2₃)₂□H₂O (cobalt nitrate) and 13.80 g (77 mol) of glucose in 20 mL of water. A volume of aqueous solution comprising 12 mg (0.5 mmol) of BN was added to the above aqueous solution. This reaction mixture was then spray dried to make a W—C—Co—BN pre-composite powder. This precursor powder is then transferred into a high temperature furnace and carburized under a mixture of H₂/CO gas using a heating rate of 110° C./min and reaction time of 30 minutes, thereby producing nanostructured WC/Co comprising the BN grain growth inhibitor.

### Example 9

### In-Situ Synthesis of Alloyed Nanostructured Powders with Grain Growth Inhibitor

An aqueous solution was prepared by dissolving 22.64 g (7.7 mmol) of ammonium metatungstenate, 9.88 g (34 mmol) cobalt nitrite, and 13.80 g (77 mol) glucose in 20 mL of water. A volume of aqueous solution comprising 12 mg (0.5 mmol) of BN polymeric precursor was added to the above aqueous solution. A mixture comprising 0.2 g (3.3 mmol) of TiC, 0.0002 g of Cr and 0.02 g (0.2 mmol) of Mo was then added to make a reaction mixture comprising 0.06 wt % BN, 0.1 wt. % Mo, 0.01 wt. % Cr, and 1 wt. % TiC with respect to WC. This reaction mixture is then spray dried to make a W—C—Co—BN pre-composite powder containing the alloying additives. This precursor powder is then transferred into a high temperature furnace and carburized under a mixture of H₂/CO gas using a heating rate of 10° C./min and reaction time of 30 minutes, thereby producing nanostructured WC/Co alloyed with Ti, Cr, and Mo and comprising the BN grain growth inhibitor.

### Example 10

### Alloy additives and BN Grain Growth Inhibitor in Nanostructured WC/Co

A series of compositions were prepared using 6 g (0.1 mol) TiC, 0.06 g (1.2 mmol) Cr, 0.6 g (6.3 mmol) Mo, and 29 mL of a 1 molar solution of the BN precursor added to 600 g of nanostructured WC/Co having varying amounts of Co (used as received from Nanodyne) to form compositions having 1 wt. % TiC, 0.01 wt. % Cr, 0.1% Mo, and 0.06 wt. % BN with respect to WC/Co, where the Co varied from 6 to 15 wt. %. The powders were then thoroughly mixed via ball milling to form an intermediate powder composition, followed by either spray drying or oven drying.

One part of the intermediate powder composition was spray dried to form spherical WC/Co composites containing BN grain growth inhibitor and the alloying additives. Such composites are useful either as thermal spray feedstock materials or for bulk consolidation.

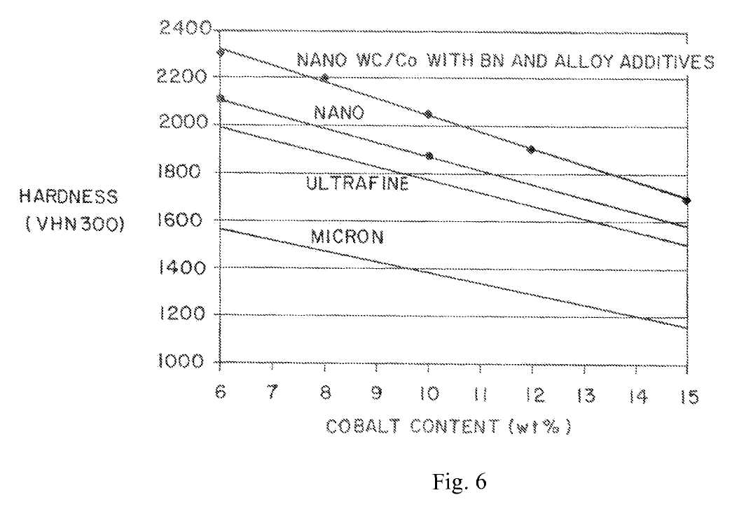

Another part of the intermediate powder composition was consolidated into 1 cm discs via a hydraulic press, and heat treated at 1400° C. under flowing H₂ gas using a heating rate of 10° C./minute and a dwell time of 0.5 hour. After heat treatment, the resultant pellets had shrunk to approximately half of their original sizes, and had densified to varying degrees up to near theoretical or 100% density. The hardness of these WC/Co consolidated pellets comprising BN and Cr and Ti alloying agents varies from 1900 up to 2400 VHN as the wt. % of Co varies from 15 wt. % to 6 wt. %. A comparison of the results of plotting hardness vs. Co content for nanostructured WC/Co containing the grain growth inhibitor and alloy additives, and for nanostructured WC/Co without any alloy additives and/or grain growth inhibitor is shown in FIG. 6.

The toughness of the nanostructured WC/Co containing grain growth inhibitor and alloy additives is also increased relative to WC/Co with no grain growth inhibitor or alloying additives. For example, with no grain growth inhibitor or allying additives, typical WC-10Co has a toughness of 10 to 12 (MPa)*(meter^{1/2}), whereas the toughness of the nanostructured WC/Co containing alloy additives and the polymeric grain growth inhibitor is from 15 to 30 (MPa)*(meter^{1/2}).

### Example 11

### Alloy Additives and BN Grain Growth Inhibitor in Submicron Sized WC/Co

Submicron-sized (0.2 micron) WC and micron-sized (1-5 micron) Co were purchased from Dow Chemical. 6 g (0.1 mol) TiC, 0.06 g (1.2 mmol) Cr, 0.6 g (6.3 mmol) Mo, and 29 mL of an aqueous 1 molar solution of BN precursor were added to 600 g of submicron WC/Co to make compositions having 1 wt. % TiC, 0.01 wt. % Cr, 0.1% Mo, 0.06 wt. % BN with respect to WC/Co, where the Co varies from 6 to 15 wt. %. The powders were then thoroughly mixed via ball milling to produce intermediate powder compositions that were either spray dried or oven dried.

Part of the intermediate powder composition was spray dried to form spherical WC/Co composite containing BN grain growth inhibitor and the alloying additives. Such compositions are useful either as thermal spray feedstock materials or for bulk consolidation.

Part of the intermediate powder was also consolidated into 1 cm discs via a hydraulic press, and heat treated at 1400° C. under flowing H₂ gas using a heating rate of 10° C./minute and a dwell time of 0.5 hour. After heat treatment, the resultant pellets had shrunk and had densified to varying degrees up to near theoretical or 100% density. The hardness of the produced pellet comprising WC/Co with alloy and grain growth inhibitor varies from 1600 up to 1900 VHN, as the wt. % of Co varies from 15 wt. % to 6 wt. %.

Conventional alloying techniques have generally comprised blending of micron-sized powders to form a mixture, followed by melting at high temperature to obtain the alloyed material. In contrast, a particularly favorable feature of the present invention is the use of soluble or low-melting grain growth inhibitor precursors and/or alloying additives to obtain uniform mixing with the superfine materials. It is also possible to use these techniques to incorporate controlled quantities of grain growth inhibitors into nanostructured materials, thereby allowing the controlled growth of nanostructured particles to superfine particles.

### Example 12

### Addition of Titania to Alumina Superfine Material

Commercial superfine Al₂O₃ (grain size of 100 to 500 nm) was obtained from Alcoa, and commercial TiO₂ (grain size of 100 to 500 nm) was obtained from Dupont for use as a grain growth inhibitor. A composite mixture containing 87 wt. % Al₂O₃ and 13 wt. % TiO₂ was made by the following procedure.

First, 3.472 kg of the Al₂O₃ and 0.528 kg of the TiO₂, both having a particle size of 100 to 500 nm, were mixed using a blending and mixing technique. The powder mixture was then ball milled to obtain a more homogeneous mixture and to de-agglomerate the mixture. The ball milled mixture was dispersed in H₂O to form a viscous slurry. A dispersant was used to achieve the optimal colloidal solution of the de-agglomerated powder. PVA was also added at this stage as a binder material. The slurry was then spray dried to form reconstituted composite spherical agglomerates. The reconstituted composite was then heated from room temperature to 1200° C. The heat treated agglomerates was then screened and air classified to obtain a particle size distribution of −45 to +5 microns, making the composite suitable for use as a thermal spray feedstock. Each agglomerate contained many individual sub-particles having sizes of 0.1 to 0.5 microns.

Some of the reconstituted powders were also plasma reprocessed. The plasma reprocessed powders had a higher tapping density of up to 2.0 to 2.4 g/cc, similar to the nanostructured powder counterparts. Both of the heat treated and plasma treated powders were used as thermal spray feedstock.

### Example 13

### Addition of Titania and Ceria to Alumina Superfine Material

Commercial superfine Al₂O₃ (grain size of 100 to 500 nm) was obtained from Alcoa, commercial TiO₂ (grain size of 100 to 500 nm) was obtained from Dupont for use as a grain growth inhibitor, and commercial CeO₂ (grain size of 100 to 500 nm) was obtained from a Chinese vendor for use as a grain growth inhibitor. A mixture containing 87 wt. % Al₂O₃ and 13 wt. % TiO₂ was formed. Also, 6 wt. % CeO₂ was added to the resulting mixture, followed by reprocessing the mixture using the following procedure.

First, 3.472 kg of the Al₂O₃, 0.528 kg of the TiO₂, and 0.24 lbs. of the CeO₂, all having a particle size of 100 to 500 nm, were mixed using a blending and mixing technique. The powder mixture was then ball milled to obtain a more homogeneous mixture and to de-agglomerate the mixture. The ball milled mixture was dispersed in H₂O to form a viscous slurry. A dispersant was used to achieve the optimal colloidal solution of the de-agglomerated powder. PVA was also added at this stage as a binder material. The slurry was then spray dried to form reconstituted composite spherical agglomerates. Next, the reconstituted composite was heated from room temperature to 1200° C. The heat treated agglomerates were then screened and air classified to obtain a particle size distribution of −45 to +5 microns, making the composite suitable for use as a thermal spray feedstock. Each agglomerate contained many individual sub-particles having sizes of 0.1 to 0.5 microns. Some of the reconstituted powders were also plasma reprocessed. The plasma reprocessed powders had a higher tapping density of up to 2.0 to 2.4 g/cc, similar to the nanostructured powder counterparts.

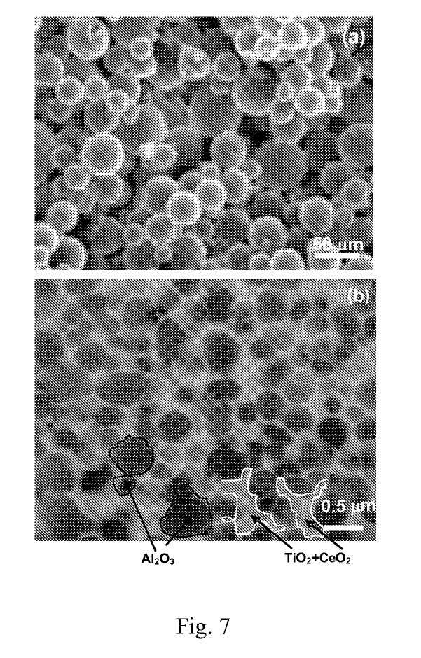

Both of the heat treated and plasma treated powders were used as thermal spray feedstock to form high quality coatings. FIG. 7 depicts SEM micrographs of the thermal spray feedstock having alumina as a primary phase and titania and ceria as grain growth inhibitors, wherein the micrographs show (a) the general morphology of the composite and (b) the composite at higher magnification. The obtained coatings had a hardness of 850 to 1000 VHN, a Rockwell C hardness of 60, a coating porosity of less than 2% based on an optical examination, and a bond strength of greater than 4000 psi.

### Example 14

### Addition of Titania, Zirconia, and Yttria to Alumina Superfine Material

Commercial superfine Al₂O₃ (grain size of 100 to 500 nm) was obtained. Also, commercial TiO₂ (grain size of 100 to 500 nm), commercial Y₂O₃ (grain size of 100 to 500 nm), and commercial ZrO₂ (grain size of 100 to 500 nm) were obtained for use as grain growth inhibitors. A mixture containing 87 wt. % Al₂O₃ and 13 wt. % TiO₂ was formed. Also, 0.7 wt. % Y₂O₃ and 9.3 wt % ZrO₂ was added to the resulting mixture, followed by reprocessing the mixture using the following procedure.

First, 3.073 kg of the Al₂O₃ (particle size of 200 to 500 nm), 0.467 kg of the TiO₂ (particle size of 200 to 500 nm), 32.2 g of the Y₂O₃, and 427.8 g of the ZrO₂ were mixed using a blending and mixing technique. The powder mixture was then ball milled to obtain a more homogeneous mixture and to de-agglomerate the mixture. The ball milled mixture was dispersed in H₂O to form a viscous slurry. A dispersant was used to achieve the optimal colloidal solution of the de-agglomerated powder. PVA was also added at this stage as a binder material. The slurry was then spray dried to form reconstituted composite spherical agglomerates. The reconstituted composite was then heated from room temperature to 1200° C. The heat treated agglomerates was then screened and air classified to obtain a particle size distribution of −45 to +5 microns, making the composite suitable for use as a thermal spray feedstock. Each agglomerate contained many individual sub-particles having sizes of 0.1 to 0.5 microns. Some of the reconstituted powders were also plasma reprocessed. The plasma reprocessed powders had a higher tapping density of up to 2.0 to 2.4 g/cc, similar to the nanostructured powder counterparts.

Both of the heat treated and plasma treated powders were used as thermal spray feedstock to form high quality coatings. The obtained coatings had a hardness of 850 to 1000 VHN, a Rockwell C hardness of 60, a coating porosity of less than 2% based on an optical examination, and a bond strength of greater than 4000 psi.

### Example 15

### Addition of Titania, Zirconia, Ceria, and Yttria to Alumina Superfine Material

Commercial superfine Al₂O₃ (grain size of 100 to 500 nm) was obtained. Also, commercial TiO₂ (grain size of 100 to 500 nm), commercial CeO₂ (grain size of 100 to 500 nm), commercial Y₂O₃ (grain size of 100 to 500 nm), and commercial ZrO₂ (grain size of 100 to 500 nm) were obtained for use as a grain growth inhibitor. A mixture containing 87 wt. % Al₂O₃ and 13 wt. % TiO₂ was formed. Also, 6 wt. % CeO₂, 0.7 wt. % Y₂O₃, and 9.3 wt % ZrO₂ was added to the resulting mixture, followed by reprocessing the mixture using the following procedure.

First, 2.604 kg of the Al₂O₃ (particle size of 200 to 500 nm), 0.396 kg of the TiO₂ (particle size of 200 to 500 nm), 0.18 kg of the CeO₂, 25.2 grams of the Y₂O₃, and 334.8 grams of the ZrO₂ were mixed using a blending and mixing technique. The powder mixture was then ball milled to obtain a more homogeneous mixture and to de-agglomerate the mixture. The ball milled mixture was dispersed in H₂O to form a viscous slurry. A dispersant was used to achieve the optimal colloidal solution of the de-agglomerated powder. PVA was also added at this stage as a binder material. The slurry was then spray dried to form reconstituted composite spherical agglomerates. The reconstituted composite was then heated from room temperature to 1200° C. The heat treated agglomerates were then screened and air classified to obtain a particle size distribution of −45 to +5 microns, making the composite suitable for use as a thermal spray feedstock. Each agglomerate contained many individual sub-particles having sizes of 0.1 to 0.5 microns. Some of the reconstituted powders were also plasma reprocessed. The plasma reprocessed powders had a higher tapping density of up to 2.0 to 2.4 g/cc, similar to the nanostructured powder counterparts.

Both of the heat treated and plasma treated powders were used as thermal spray feedstock to form high quality coatings. The obtained coatings had a hardness of 850 to 1000 VHN, a Rockwell C hardness of 60, a coating porosity of less than 2% based on an optical examination, and a bond strength of greater than 4000 psi.

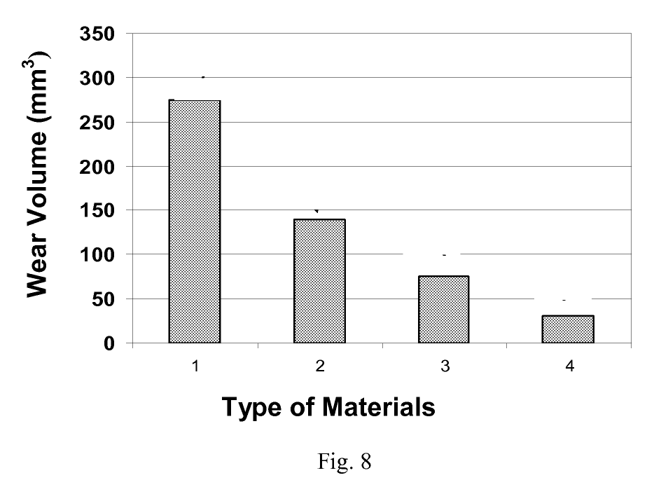

FIG. 8 illustrates the abrasive wear resistance of various grades of Al₂O₃ coatings, including the coatings formed above. In particular, it compares the wear volumes of the following materials: coating 1 is a micron sized Al₂O₃ coating with 13 wt. % TiO₂ added as a grain growth inhibitor, coating 2 is a nanostructured Al₂O₃ coating with 13 wt. % TiO₂ added as a grain growth inhibitor, coating 3 is a superfine Al₂O₃ coating with 13 wt. % TiO₂, 6 wt. % CeO₂, 0.7 wt. % Y₂O₃, and 9.3 wt. % ZrO₂ added as grain growth inhibitors, and coating 4 is a nanostructured Al₂O₃ coating with 13 wt. % TiO₂, 6 wt. % CeO₂, 0.7 wt. % Y₂O₃, and 9.3 wt. % ZrO₂ added as grain growth inhibitors. Based on the results shown in FIG. 8, the superfine coating exhibited several orders of improvement in wear resistance compared to the coating deposited using METCO 130 commercial powder (i.e., unmodified micron sized Al₂O₃/TiO₂), which had the highest wear volume of all the coatings, i.e. the lowest wear resistance. The wear resistances of the nanostructured (grain size of 1 to 100 nm) coatings were also higher than that of the coating deposited using the METCO 130 commercial powder.

### Example 16

### Addition of TiO₂ to Chromia Superfine Material

Commercial Cr₂O₃ (grain size of 100 to 500 nm) was obtained from LaPorte Pigment, and commercial TiO₂ (grain size of 100 to 500 nm) was obtained from Dupont. A composite mixture containing 90 wt. % of Cr₂O₃ and 10 wt. % TiO₂ was made by the following procedure.

First, 0.5 kg of the Cr₂O₃ and 0.061 kg of the TiO₂ were mixed using a blending and mixing technique. The powder mixture was then ball milled to obtain a more homogeneous mixture and to de-agglomerate the mixture. The ball milled mixture was dispersed in H₂O to form a viscous slurry. PVA was also added at this stage as a binder material. The slurry was then spray dried to form reconstituted composite spherical agglomerates. The reconstituted composite was then heated from room temperature to 1600° C. The sintered composite formed a loosely sintered block. This block was then crushed into powders, followed by hammer milling, screening, and air classification to form a powder having a tapping density of about 3.1 g/cc. The obtained particle size ranged from 5 to 50 microns, while each particle was an assemblage of many individual sub-particles having a particle size of 0.1 to 0.5 microns. This composite powder was then plasma sprayed to form a coating.

### Example 17

### Addition of Titania and Ceria to Chromia Superfine Material

Commercial Cr₂O₃ (grain size of 100 to 500 nm) was obtained, and commercial TiO₂ (grain size of 100 to 500 nm) and commercial ceria (grain size of 100 to 500 nm) were obtained for use as grain growth inhibitors. A mixture containing 90 wt. % of Cr₂O₃ and 10 wt. % TiO₂ was formed. Also, 6 wt. % CeO₂ was added to the resulting mixture, followed by reprocessing the mixture using the following procedure.

First, 0.5 kg of the Cr₂O₃, 0.061 kg of the TiO₂, and 0.036 kg of the CeO₂ were mixed using a blending and mixing technique. The powder mixture was then ball milled to obtain a more homogeneous mixture and to de-agglomerate the mixture. The ball milled mixture was dispersed in H₂O to form a viscous slurry. PVA was also added at this stage as a binder material. The slurry was then spray dried to form reconstituted composite spherical agglomerates. The reconstituted composite was then heated from room temperature to 1400° C. The sintered composite formed a loosely sintered block. This block was then crushed into powders, followed by hammer milling, screening, and air classification to form a powder having a tapping density of about 3.0 g/cc. The obtained particle size ranged from 5 to 50 microns, while each particle was an assemblage of many individual sub-particles having a particle size of 0.1 to 0.5 microns. This composite powder was then plasma sprayed to form a coating.

### Example 18

### Addition of Titania, Ceria, Yttria, and Zirconia to Chromia Superfine Material

Commercial Cr₂O₃ (grain size of 100 to 500 nm) was obtained, and commercial TiO₂ (grain size of 100 to 500 nm), commercial ceria (grain size of 100 to 500 nm), commercial yttria (grain size of 100 to 500 nm), and commercial zirconia (grain size of 100 to 500 nm) were obtained for use as grain growth inhibitors. A mixture containing 90 wt. % of Cr₂O₃ and 10 wt. % TiO₂ was formed. Also, 6 wt. % CeO₂, 0.3 wt. % Y₂O₃, and 9.3 wt. % ZrO₂ were added to the resulting mixture, followed by reprocessing the mixture using the following procedure.

First, 3.5 kg of the Cr₂O₃, 0.389 kg of the TiO₂, 0.194 kg of the CeO₂, 21.77 g of the Y₂O₃, and 289.23 g of the ZrO₂ were mixed using a blending and mixing technique. The powder mixture was then ball milled to obtain a more homogeneous mixture and to de-agglomerate the mixture. The ball milled mixture was dispersed in H₂O to form a viscous slurry. PVA was also added at this stage as a binder material. The slurry was then spray dried to form reconstituted composite spherical agglomerates. The reconstituted composite was then heated from room temperature to 1200° C., 1300° C., 1400° C., 1500° C., and 1600° C. Properties of the reconstituted powder at the various temperature stages of the process are listed in Table 3 below.

TABLE 3

Density

| Powder process | Tapping | | Hall Flow |
|---|---|---|---|
| conditions | (g/cc) | Theoretical (%) | (g/min) |
| As spray dried | 1.499 | 29.4 | 38.4 |
| 1200° C. | 1.428 | 28 | No |
| 1300° C. | 1.52 | 29.8 | No |
| 1400° C. | 3.198 | 62.6 | Yes* |
| 1600° C. | 3.413 | 66.9 | Yes* |

*Powder can only flow through the Hall flow meter assisting with initial tapping by hand.

The reprocessed powders were further plasma sprayed to form coatings using a METCO 9 MB gun. The obtained coatings had a hardness of 950 to 1100 VHN, a Rockwell hardness of 67, a coating porosity of less than 2% when examined optically, and a bond strength of greater than 4700 psi. It should be noted that conventional Cr₂O₃ coatings have slightly lower hardness values (microhardness of 900 VHN, Rockwell hardness of 65) and slightly lower bond strengths (4000 to 4500 psi).

### Example 19

### Addition of Yttria to Zirconia Superfine Material

A commercial powder containing 93 wt. % ZrO₂ and 7 wt. % Y₂O₃ were obtained from Tosh. This material was chemically synthesized to have a particle size of 100 to 200 nm. Next, 10 kg of the powder were loaded into an attrition milling machine with H₂O added. The powder was then ball milled to de-agglomerate the mixture and form a uniform slurry. PVA was also added at this stage as a binder material. The slurry was then spray dried to form reconstituted composite spherical agglomerates. The reconstituted composite was then heated from room temperature to 1200° C. Next, the heat treated agglomerates were screened and air classified to obtain a particle size distribution of −100 and +15 microns, making the composite suitable for use as a thermal spray feedstock. Each agglomerate contained many individual sub-particles having sizes of 0.1 to 0.5 microns. This composite powder was then plasma sprayed to form a coating.

As used herein, the terms “a” and “an” do not denote a limitation of quantity, but rather denote the presence of at least one of the referenced items. Moreover, the endpoints of all ranges directed to the same component or property are inclusive of the endpoint and independently combinable (e.g., “up to about 25 wt. %, or, more specifically, about 5 wt. % to about 20 wt. %,” is inclusive of the endpoints and all intermediate values of the ranges of “about 5 wt. % to about 25 wt. %,” etc.). Reference throughout the specification to “one embodiment”, “another embodiment”, “an embodiment”, and so forth means that a particular element (e.g., feature, structure, and/or characteristic) described in connection with the embodiment is included in at least one embodiment described herein, and may or may not be present in other embodiments. All cited patents, patent applications, and other references are incorporated herein by reference in their entirety. However, if a term in the present application contradicts or conflicts with a term in the incorporated reference, the term from the present application takes precedence over the conflicting term from the incorporated reference. In addition, it is to be understood that the described elements may be combined in any suitable manner in the various embodiments. Unless defined otherwise, technical and scientific terms used herein have the same meaning as is commonly understood by one of skill in the art to which this invention belongs.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A thermal spray feedstock composition, comprising:
a superfine ceramic material comprising grains having an average longest dimension of about 100 nanometers to about 500 nanometers; and
a grain growth inhibitor comprising a ceramic oxide different from the superfine ceramic material.

2. The thermal spray feedstock composition of claim 1, wherein the ceramic oxide comprises a transition metal oxide, an alkaline earth metal oxide, a rare earth element oxide, a metalloid oxide, a different metal oxide, or a combination comprising at least one of the foregoing ceramic oxides.

3. The thermal spray feedstock composition of claim 1, wherein an amount of the grain growth inhibitor present in the superfine composition is about 0.1 weight % to about 50 weight % based on a weight of the superfine ceramic material.

4. The thermal spray feedstock composition of claim 1, wherein particles of the superfine ceramic material are dispersed in a matrix phase of the ceramic oxide.

5. The thermal spray feedstock composition of claim 1, wherein the ceramic oxide is uniformly mixed with the superfine ceramic material.

6. The thermal spray feedstock composition of claim 1, wherein the superfine ceramic material comprises alumina, titania, chromia, zirconia, or a combination comprising at least one of the foregoing materials.

7. The thermal spray feedstock composition of claim 1, wherein the ceramic oxide comprises titania, alumina, yttria, ceria, scandia, zirconia, silica, magnesium oxide, calcium oxide, or a combination comprising at least one of the foregoing materials.

8. The thermal spray feedstock of claim 1, wherein the ceramic oxide comprises grains having an average longest dimension of about 100 nanometers to about 500 nanometers.

9. A method of making a superfine composition for use in thermal spraying, comprising:
mixing a superfine ceramic material comprising grains having an average longest dimension of about 100 nanometers to about 500 nanometers with a ceramic oxide grain growth inhibitor that is different from the superfine ceramic material to form a solid mixture;
combining the solid mixture with a liquid to form a slurry; and
spray drying the slurry to form a reconstituted composite material.

10. The method of claim 9, further comprising ball milling the solid mixture subsequent to said mixing.

11. The method of claim 9, wherein the liquid comprises water or an organic.

12. The method of claim 9, further comprising incorporating a binder into the slurry prior to said spray drying.

13. The method of claim 9, further comprising heat treating the reconstituted composite material.

14. The method of claim 9, wherein the reconstituted composite material comprises agglomerates, and further comprising screening the agglomerates and subjecting the agglomerates to air classification to obtain a select portion of the agglomerates.

15. The method of claim 14, further comprising hammer milling a non-select portion of the agglomerates.

16. The method of claim 9, wherein the ceramic oxide grain growth inhibitor comprises a transition metal oxide, an alkaline earth metal oxide, a rare earth element oxide, a metalloid oxide, a different metal oxide, or a combination comprising at least one of the foregoing ceramic oxides.

17. The method of claim 9, wherein an amount of the ceramic oxide grain growth inhibitor present in the superfine composition is about 0.1 weight % to about 50 weight % based on a weight of the superfine ceramic material.

18. The method of claim 9, wherein the superfine ceramic material comprises alumina, titania, chromia, zirconia, or a combination comprising at least one of the foregoing materials.

19. The method of claim 9, wherein the ceramic oxide grain growth inhibitor comprises titania, alumina, yttria, ceria, scandia, zirconia, silica, magnesium oxide, calcium oxide, or a combination comprising at least one of the foregoing materials.

20. A method of coating a surface, comprising: thermal spraying a superfine composite material to form a coating on the surface, the composite material comprising:
a superfine ceramic material comprising grains having an average longest dimension of about 100 nanometers to about 500 nanometers; and
a grain growth inhibitor comprising a ceramic oxide different from the superfine ceramic material.

21. The method of claim 20, wherein the ceramic oxide reduces grain growth of the superfine ceramic material during said thermal spraying.

22. The method of claim 20, wherein the ceramic oxide comprises a transition metal oxide, an alkaline earth metal oxide, a rare earth element oxide, a metalloid oxide, a different metal oxide, or a combination comprising at least one of the foregoing ceramic oxides.

23. The method of claim 20, wherein an amount of the grain growth inhibitor present in the superfine composition is about 0.1 weight % to about 50 weight % based on a weight of the superfine ceramic material.

24. The method of claim 20, wherein the superfine ceramic material comprises alumina, titania, chromia, zirconia, or a combination comprising at least one of the foregoing materials.

25. The method of claim 20, wherein the ceramic oxide comprises titania, alumina, yttria, ceria, scandia, zirconia, silica, magnesium oxide, calcium oxide, or a combination comprising at least one of the foregoing materials.
